(19) United States
(12) Patent Application Publication
(10) Pub. No.: US 2011/0210817 A1
(43) Pub. Date: Sep. 1, 2011

(54) LIGHT FOR AT LEAST ONE LED AND TRANSMITTER FOR GENERATING A RADIO SIGNAL FOR SUCH A LIGHT

(75) Inventors: Zoran Bosnjak, Muenchen (DE); Jeanine Chrobak-Kando, Appenweier (DE); Harald Dellian, Edling (DE); Gert Wemmer, Landshut (DE)

(73) Assignee: OSRAM GESELLSCHAFT MIT BESCHRAENKTER HAFTUNG, Muenchen (DE)

(21) Appl. No.: 12/672,901

(22) PCT Filed: Aug. 10, 2007
(86) PCT No.: PCT/EP2007/058297

§ 371 Date: Feb. 10, 2010

(51) Int. Cl. H04L 7/00; H02J 13/00

(52) U.S. Cl. 340/4.21; 340/9.1

(57) ABSTRACT

A lamp may include at least one LED; a solar module; an accumulator; charging electronics coupled between the solar module and the accumulator; a drive circuit for the at least one LED, which is coupled to the accumulator; a receiver which is coupled to the accumulator and is configured to receive a radio signal; and a processing device which is coupled to the accumulator and the receiver and is configured to form at least one drive signal for the drive circuit from the data received with the radio signal.

### TECHNICAL FIELD

The present invention relates to a lamp having at least one LED, a solar module, an accumulator, charging electronics coupled between the solar module and the accumulator, and a drive circuit for the at least one LED, which is coupled to the accumulator. It furthermore relates to a transmitter for generating a radio signal for such a lamp.

### PRIOR ART

A lamp of the species is known. In it, solar energy for the night is stored during the day and, as soon as it is dark, the known lamp switches on automatically and makes it possible for example to identify sidewalks or illuminate house numbers, or is used as a spotlamp or as a floating light or as a garden lamp.

### SUMMARY OF THE INVENTION

It is an object of the present invention to refine a lamp of the species so as to open up further possible uses.

This object is achieved by a lamp having the features of claim 1. According to a second aspect, the present invention also provides a transmitter as claimed in claim 15 for generating a radio signal for a lamp according to the invention.

The present invention is based on the discovery that the possible uses of LED lamps of the species can be widened when measures are provided to control a lamp wirelessly. To this end, a lamp according to the invention includes a receiver which is coupled to the accumulator and is configured to receive a radio signal, and a processing device which is coupled to the accumulator and the receiver and is configured to form at least one drive signal for the drive circuit from the data received with the radio signal. Depending on the LED or LEDs used, it is thereby possible to generate colored patterns, color animations or script, particularly in a two-dimensional surface, two- or three-dimensional types of artwork in particular also being envisageable here.

Unlike in the prior art, where there is the risk that different lamps will switch on at different times owing to the production-related deviations of the brightness sensors required for switching them on, by wireless driving of an LED lamp according to the invention it is possible to switch one or more LED lamps on and off simultaneously.

The lamp furthermore preferably includes a memory device coupled to the accumulator. This provides the opportunity to transmit a light sequence just once by a radio signal, this light sequence being stored in the memory device and executed either continually or on demand. In particular, the memory device stores instructions that specify which color of light is intended to be emitted by a lamp according to the invention for which duration.

With a view to a large power range of the light to be emitted by the lamp, the lamp preferably includes a voltage transformer, in particular a step-up transformer. The accumulator voltage, which is conventionally of the order of 2.4 V, can thereby be converted to higher values which can then be used to drive the at least one LED.

In this context, it is preferable for the lamp furthermore to include a microcontroller and a current source.

The at least one LED is preferably an RGB LED. As an alternative, it is preferable for the lamp to include at least three differently colored LEDs. This provides the opportunity to drive the lamp in such a way that the light emitted by it varies in color.

The memory device preferably includes an address memory which is configured to store an address in it so as to allocate address-specific data, transmitted with the radio signal, to the lamp. In this way, an assembly of a plurality of lamps according to the invention can be assigned different addresses or the same address, and address-specific light sequences can be transmitted by a transmitter according to the invention and stored in the memory devices of the respective lamps. Individual lamps or different groups of lamps can thereby emit desired light signals at desired times. This furthermore allows subsequent fitting of lamps according to the invention, or replacement of defective lamps according to the invention, inexpensively since a lamp according to the invention does not need to have a transmitter in order to register the corresponding lamp at a control center.

The lamp particularly preferably includes an activation device, in particular a pushbutton. By operating the activation device, the lamp may be put into a state in which an address can be entered into the lamp. An address is preferably input before the lamp(s) is/are installed. The activation device may in particular be configured, after it is activated, to put the lamp into a state in which it is configured to receive an address sent by a radio signal and store it in the address memory. It is particularly advantageous for the lamp furthermore to be configured to acknowledge successful storage of an address, in particular by an optical and/or acoustic signal. In this way, an operator can easily establish whether the transmission and storage of an address has succeeded, or whether the process must be repeated.

The lamp may furthermore be configured, when no address has yet been entered in the address memory, without activation of the activation device to enter a state in which it is configured to receive an address sent by a radio signal and store it in the address memory. This provides the opportunity to allow initial address transmission without activating the activation device.

In a preferred refinement of a lamp according to the invention, the processing device includes a chronometer device, which for its part includes a quartz oscillator. The processing device is then preferably configured to synchronize the chronometer device with corresponding data received with the radio signal, the processing device furthermore being configured to put the drive signal for the drive circuit into a temporal relationship with a signal emitted by the chronometer device, and in particular synchronize it therewith. This measure provides the opportunity to synchronize different lamps according to the invention with one another. For example, synchronization may be carried out every hour, the quartz oscillator internal to the lamp providing the clock signal during the hour. According to experience, the range of deviation of a plurality of lamps from one another during an hour is of the order of 1 to 5 ms and is therefore not conspicuous to an observer.

In a preferred embodiment of a transmitter according to the invention, the transmitter has a memory device for storing the data to be sent with the radio signal. In this case, the data stored in the memory device represent in particular at least one light sequence for at least one lamp.

It is furthermore preferable for the transmitter to include an interface for transmitting data which represent at least one light sequence for at least one lamp.

The interface preferably constitutes an interface to a PC, in particular a WLAN or USB interface. With appropriate software and a graphical user interface, this provides the user with the opportunity to program light sequences on the PC. They are subsequently sent via said interface to the transmitter, where they are buffered in the memory device. These light sequences can subsequently be transmitted to the lamps according to the invention, in particular address-specifically, by radio. It is furthermore preferable for the transmitter to include a solar module and/or a compartment for a battery. In this way, particularly in conjunction with a WLAN interface, the transmitter can also be installed independently of a mains connection.

The transmitter may preferably include an address transmission device, in particular a pushbutton, which is configured after it is activated to send at least one address to at least one lamp. A particularly simple option is for the address to be a sequential address. In particular when subsequently fitting further lamps in an existing assembly, however, the address may also be a predeterminable address.

A preferred refinement of a transmitter according to the invention includes a clock generator. The clock generator is then preferably configured to transmit a synchronization signal to at least one lamp at predeterminable times. This provides the opportunity to synchronize a plurality of lamps combined in an assembly.

Even complex light sequences can thereby be achieved without problems.

It is furthermore preferable for the transmitter to be configured to transmit a switch-on and/or switch-off signal to the at least one lamp. In this way, one or more lamps can be switched on and off in a controlled way. In this context, it is particularly preferable for the transmitter furthermore to include a brightness measuring device and be configured to transmit the switch-on and/or switch-off signal as a function of a brightness measured by the brightness measuring device. In this way, a multiplicity of lamps can be controlled as a function of the brightness, without entailing the risk that lamps respectively equipped with a brightness measuring device, which differ owing to manufacture, may switch on at different times.

Lastly, the transmitter may furthermore include a chronometer device and be configured to transmit the switch-on and/or switch-off signal at predeterminable times. This provides the opportunity to automatically switch a multiplicity of lamps on and off almost simultaneously.

Other advantageous embodiments may be found in the dependent claims.

### BRIEF DESCRIPTION OF THE DRAWINGS

The invention will be explained in more detail below with the aid of an exemplary embodiment. In the figures:

FIG. 1 shows a schematic representation of the structure of an exemplary embodiment of a lamp according to the invention;

FIG. 2 shows a schematic representation of a lamp according to the invention and a transmitter according to the invention;

FIG. 3 shows a schematic representation to illustrate the transmission of data, which represent light sequences, from a PC to a transmitter according to the invention;

FIG. 4 shows an arrangement having a multiplicity of lamps according to the invention; and

FIG. 5 shows the arrangement of FIG. 4, including a transmitter according to the invention.

### PREFERRED EMBODIMENT OF THE INVENTION

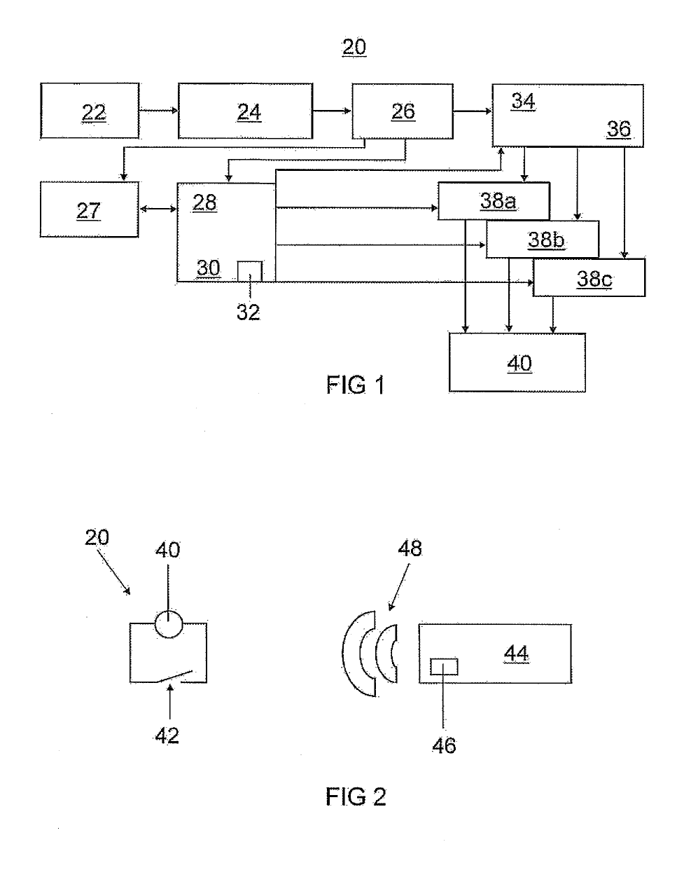

FIG. 1 shows a schematic representation of the structure of an exemplary embodiment of a lamp 20 according to the invention. It includes a solar module 22, also referred to as a photovoltaic module or solar generator, which is configured in particular to convert sunlight directly into electrical power. It includes a panel of glass, usually so-called single-layer safety glass, a transparent plastic layer in which the solar cells are embedded, and a plurality of monocrystalline or polycrystalline solar cells which are electrically interconnected by solder strips. The rear cover is usually made using a weatherproof composite plastic sheet. The solar module drives charging electronics 24, which in turn are configured to charge an accumulator 26. The accumulator supplies a microcontroller 28, a memory device 30 which includes an address memory 32, and a step-up transformer 34 which is assigned exhaustive discharge protection 36, and a receiver 27 which is configured to receive a radio signal. The step-up transformer 34 drives three current regulators 38a to c, each current regulator being assigned one color of an RGB LED 40. The current regulators 38a to c are activated color-specifically by the microcontroller 28 and the memory device 30, as well as the address memory 32. The microcontroller 28 furthermore drives the step-up transformer 34.

FIG. 2 shows a representation, expanded relative to FIG. 1, of a lamp 20 according to the invention. It has a pushbutton 42, the multiplicity of components of a lamp according to the invention, as presented in FIG. 1, having been omitted for the sake of clarity. The right-hand side of FIG. 2 represents a transmitter 44 according to the invention, which in turn has a pushbutton 46. The symbols 48 indicate that the transmitter sends signals to at least one lamp 20 according to the invention. When the button 42 is pressed, an address stored in the address memory 32 of a lamp 20 according to the invention is first erased if appropriate. The LED 40 flashes slowly until an address is delivered. The delivery of an address by the transmitter 44 can be initiated by means of the pushbutton 46. The transmitter may deliver addresses in a sequence stored by the user in the transmitter 44, or successively. After the pushbutton 46 is pressed, the next available address is sent by the transmitter 44 to at least one lamp 20 according to the invention, which is waiting for an address to be delivered. The latter acknowledges successful address storage with two double flashes of the LED 40. Inside the lamp 20, the address is stored in the address memory 32, which may in particular be an EEPROM.

So long as the address memory 32 is empty, for example during first use, the lamp according to the invention automatically enters the “address search” mode and waits for the allocation of an address by a transmitter 44 according to the invention.

After the address has been given, the lamp 20 according to the invention and the transmitter 44 switch back into normal operation. An existing light system can thus be extended with very little outlay. The limitation of the system resides in the maximum number of addresses which can be delivered, which is limited in particular by the software. Addresses which have been delivered but are no longer required may be erased in the software. If a plurality of lamps 20 according to the invention are simultaneously set to address storage, groups can be formed in the system.

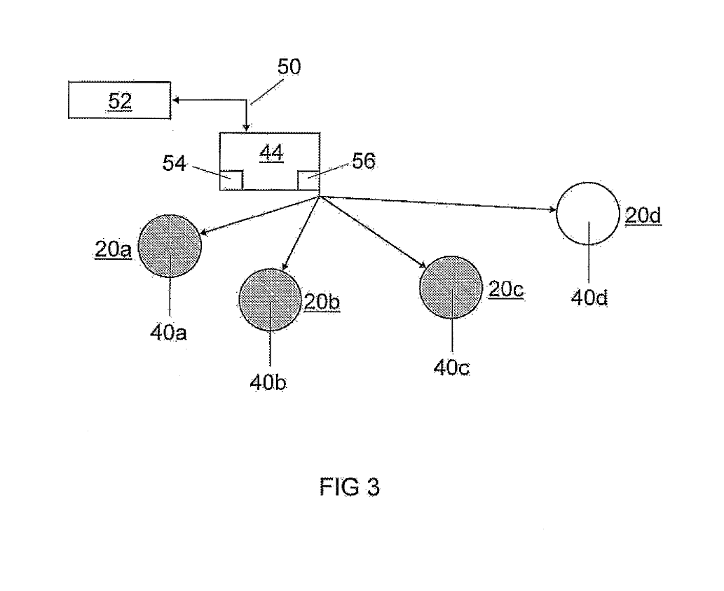

FIG. 3 shows by way of example a transmitter 44 according to the invention which drives four lamps 20a to 20d according to the invention, of which only the respective LEDs 40a to 40d are represented for the sake of clarity. The transmitter 44 is connected to a PC 52 via a USB interface 50. On the PC 52, various light sequences for the LEDs 40a to 40d can be generated and sent straightforwardly to the transmitter 44. The latter transmits the light sequences address-specifically to the lamps 20a to 20d.

The transmitter 44 transmits the individual control sequences, addressed to the lamps 20a to 20d according to the invention, once. By means of the PC 52, the user can easily send light sequences, the corresponding data, subsequently via the USB interface 50 to the transmitter 44 where they are buffered in a memory device 54. Each lamp 20a to 20d stores the light sequence assigned address-specifically to it in its memory device 30. In the present case, the transmitter 44 has a solar module 56. As an alternative, the transmitter 44 could be operated by means of a battery.

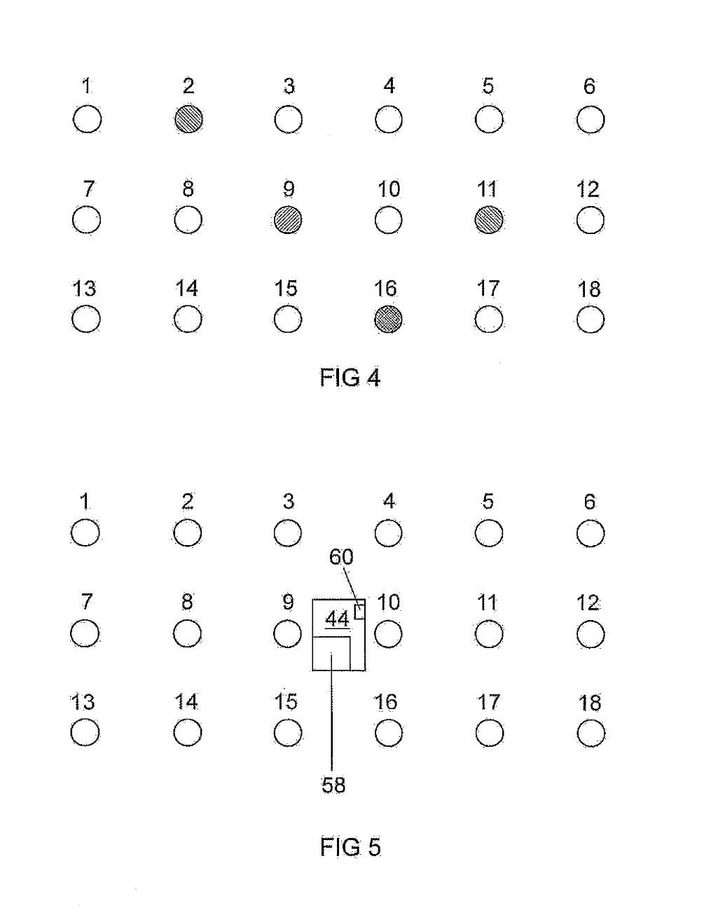

FIG. 4 shows an arrangement of 18 lamps 20 according to the invention, only the LED being indicated in each case for the sake of clarity. Each lamp 20 is assigned an address, in the present case the addresses 1 to 18. Each LED 40 is configured as an RGB LED and can display different colors at different times. In the present case, the LEDs 40 with the addresses 2 and 11 shine red, the LED 40 with the address 9 shines green and the LED 40 with the address 16 shines blue. The other LEDs 40 are not lit.

FIG. 5 shows the arrangement of FIG. 4, the transmitter 44 for driving the lamps 20 additionally being represented here. It has a clock generator 58 and a brightness measuring device 60. Each lamp 20 has a quartz oscillator (not shown). The clock generator 58 of the transmitter 44 transmits a synchronization signal to the lamps 20 at predetermined time intervals, for example every hour. The clock generator is furthermore configured to switch on or off the system consisting of the transmitter 44 and a multiplicity of lamps 20 according to the invention, for example for day/night control, by a timer circuit, etc. The clock generator 58 of the transmitter 44 is furthermore configured to transmit a switch-on and switch-off signal to the lamps 20 according to the invention as a function of a signal delivered by the brightness measuring device 60.

1. A lamp, comprising:
at least one LED;
a solar module;
an accumulator;
charging electronics coupled between the solar module and the accumulator;
a drive circuit for the at least one LED, which is coupled to the accumulator;
a receiver which is coupled to the accumulator and is configured to receive a radio signal; and
a processing device which is coupled to the accumulator and the receiver and is configured to form at least one drive signal for the drive circuit from the data received with the radio signal.

2. The lamp as claimed in claim 1,
wherein the lamp furthermore comprises a memory device coupled to the accumulator.

3. The lamp as claimed in claim 1,
wherein the lamp furthermore comprises a voltage transformer.

4. The lamp as claimed in claim 1,
wherein the lamp furthermore comprises a microcontroller and a current source.

5. The lamp as claimed in claim 1,
wherein the at least one LED is an RGB LED.

6. The lamp as claimed in claim 1,
wherein the lamp comprises at least three differently colored LEDs.

7. The lamp as claimed in claim 1,
wherein the memory device comprises an address memory which is configured to store an address in it so as to allocate address-specific data, transmitted with the radio signal, to the lamp.

8. The lamp as claimed in claim 1,
wherein the lamp comprises an activation device.

9. The lamp as claimed in claim 8,
wherein the activation device is configured to put the lamp in a state in which an address can be entered into the lamp.

10. The lamp as claimed in claim 9,
wherein the activation device is configured, after it is activated, to put the lamp into a state in which it is configured to receive an address sent by a radio signal and store it in the address memory.

11. The lamp as claimed in claim 8,
wherein the lamp is configured to acknowledge successful storage of an address.

12. The lamp as claimed in claim 8,
wherein the lamp is configured, when no address has yet been entered in the address memory, without activation of the activation device to enter a state in which it is configured to receive an address sent by a radio signal and store it in the address memory.

13. The lamp as claimed in claim 1,
wherein the processing device comprises a chronometer device, which for its part comprises a quartz oscillator.

14. The lamp as claimed in claim 13,
wherein the processing device is configured to synchronize the chronometer device with corresponding data received with the radio signal, the processing device furthermore being configured to put the drive signal for the drive circuit into a temporal relationship with a signal emitted by the chronometer device.

15. A lamp system, comprising:
a lamp, comprising:
at least one LED;
a solar module;
an accumulator;
charging electronics coupled between the solar module and the accumulator;
a drive circuit for the at least one LED, which is coupled to the accumulator;
a receiver which is coupled to the accumulator and is configured to receive a radio signal; and
a processing device which is coupled to the accumulator and the receiver and is configured to form at least one drive signal for the drive circuit from the data received with the radio signal; and
a transmitter functioning as a controller for generating a radio signal to drive the lamp.

16. The lamp system as claimed in claim 15,
wherein the transmitter of the lamp system has a memory device for storing the data to be sent with the radio signal.

17. The lamp system as claimed in claim 16,
wherein the data stored in the memory device represent at least one light sequence for at least one lamp.

18. The lamp system as claimed in claim 15,
wherein the transmitter of the lamp system comprises an interface for transmitting data which represent at least one light sequence for at least one lamp.

19. The lamp system as claimed in claim 18,
wherein the interface constitutes an interface to a PC.

20. The lamp system as claimed in claim 15,
wherein the transmitter of the lamp system comprises at least one of a solar module and a compartment for a battery.

21. The lamp system as claimed in claim 15,
wherein the transmitter of the lamp system comprises an address transfer device, which is configured after it is activated to send at least one address to at least one lamp.

22. The lamp system as claimed in claim 21,
wherein the address is an address selected from a group consisting of: a sequential address; and a predeterminable address.

23. The lamp system as claimed in claim 15,
wherein the transmitter of the lamp system comprises a clock generator.

24. The lamp system as claimed in claim 23,
wherein the clock generator is configured to transmit a synchronization signal to at least one lamp at predeterminable times.

25. The lamp system as claimed in claim 15,
wherein the transmitter of the lamp system is configured to transmit at least one of a switch-on signal and a switch-off signal to the at least one lamp.

26. The lamp system as claimed in claim 25,
wherein the transmitter of the lamp system furthermore comprises a brightness measuring device and is configured to transmit the at least one of the switch-on signal and the switch-off signal as a function of a brightness measured by the brightness measuring device.

27. The lamp system as claimed in claim 25,
wherein the transmitter of the lamp system furthermore comprises a chronometer device and is configured to transmit the at least one of the switch-on signal and the switch-off signal at predeterminable times.
